(19) United States
(12) Patent Application Publication
(10) Pub. No.: US 2024/0179579 A1
(43) Pub. Date: May 30, 2024

(54) DYNAMIC SPECTRUM ACQUISITION AND POWER MANAGEMENT FOR WIRELESS DEVICES

(71) Applicant: MICHAEL DAVIES, OTTAWA (CA)

(72) Inventor: MICHAEL DAVIES, OTTAWA (CA)

(21) Appl. No.: 18/514,383

(22) Filed: Nov. 20, 2023

Related U.S. Application Data
(60) Provisional application No. 63/384,990, filed on Nov. 25, 2022.

(51) Int. Cl. H04W 28/26; H04W 24/02; H04W 52/24; H04W 64/00

(52) U.S. Cl. CPC H04W 28/26; H04W 24/02; H04W 52/241; H04W 64/00

(57) ABSTRACT

The provisioning of wireless networks in rural environments still represents a significant issue for network operators or government regulators or authorities. This arises from a variety of factors including reduced densities of users, reduced infrastructure such as cellular network towers and increase distances coupled with seasonal variations such as inclement weather in the winter, leaves on trees during the summer etc. Embodiments of the invention allow for wireless networks and more particularly wireless devices within the wireless network to provide increased connectivity and performance within rural wireless networks whilst maintaining compliance with the applicable local, region and national requirements as defined in the applicable specifications.

### CROSS-REFERENCE TO RELATED APPLICATIONS

This patent claims the benefit of priority from U.S. Provisional Patent Application 63/384,990 filed Nov. 25, 2022; the entire contents of which are incorporated herein by reference.

### FIELD OF THE INVENTION

This patent application relates to wireless networks and more particularly to methods, processes and systems for configuring wireless devices within wireless networks to enhance network performance.

### BACKGROUND OF THE INVENTION

Wireless networks provide communications between electronic devices that be either local to one another, within a common region or country, or be internationally distributed. Whilst wireless networks have become a ubiquitous aspect of the telecommunications infrastructure offering benefits such as high connectivity, high upload and download speeds and low latency these benefits are typically evident in urban environments. The provisioning of wireless networks in rural environments, however, is still a significant issue. This arises from a variety of factors including reduced densities of users, reduced infrastructure such as cellular network towers (cell towers), and increase distances coupled with seasonal variations such as inclement weather in the winter, leaves on trees during the summer etc.

Accordingly, it would be beneficial to provide wireless networks and more particularly wireless devices within the wireless network to provide increased connectivity and performance within rural wireless networks whilst maintaining compliance with the applicable local, region and national requirements as defined in the applicable specifications.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to wireless networks and more particularly to methods, processes and systems for configuring wireless devices within wireless networks to enhance network performance.

In accordance with an embodiment of the invention there is provided a method comprising: establishing a location of a wireless device;
polling a network database to establish data relating to a number of available spectral regions for the location;
identifying a largest continuous range within the number of available spectral regions for the location as a range the wireless device wishes to declare operation upon;
transmitting to the network database data identifying that the wireless device intends to operate upon the identified largest continuous range within the number of available spectral regions at the location;
updating the network database such that the identified largest continuous range within the number of available spectral regions is reserved for that location; and
defining in dependence upon the largest continuous range within the number of available spectral regions one or more transmitter characteristics with which to operate a transmitter forming part of the wireless device at the location.

In accordance with an embodiment of the invention there is provided a device comprising:
a wireless transmitter;
a processor; and
a memory storing computer executable instructions which when executed by the processor configure the device to:
   establish a location of the device;
   poll a network database to establish data relating to a number of available spectral regions for the location;
   identify a largest continuous range within the number of available spectral regions for the location as a range the device wishes to declare operation upon;
   transmit to the network database data identifying that the device intends to operate upon the identified largest continuous range within the number of available spectral regions at the location; and
define in dependence upon the largest continuous range within the number of available spectral regions one or more transmitter characteristics with which to operate a transmitter forming part of the device at the location.

In accordance with an embodiment of the invention there is provided a method comprising:
powering on a wireless transceiver (radio) of an electronic device;
scanning with the radio a region of a wireless environment at a location of the electronic device;
ranking potential centre frequencies of operation identified by a microprocessor associated with the radio from the scan of the region of the wireless environment;
selecting with the microprocessor an operating range for the electronic device to declare based upon the ranked potential centre frequencies;
transmitting data relating to the selected operating range the electronic device is declaring to a network database;
selecting with the microprocessor an operating frequency within the selected operating range to operate upon;
defining with the microprocessor transmitter characteristics of a wireless transmitter forming part of the radio to be employed whilst transmitting upon the operating frequency; and
transmitting data from the electronic device with the radio.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which configurable electrical devices according to and supporting embodiments of the invention may be deployed and operate; and

FIG. 2 depicts a wireless device supporting communications to a network such as depicted in FIG. 1 and supporting configuration and reconfiguration according to and supporting embodiments of the invention;

FIG. 3 depicts a frame structure for a frame according to the Long-Term Evolution (LTE) standard for wireless broadband communications;

FIG. 4 depicts schematically LTE frequency domain channel configuration for a wireless network operating according to the LTE standard;

FIG. 5 depicts schematically LTE cell-specific reference signals for a single transmitter (1-Tx) antenna-system and normal cyclic prefix;

FIG. 6 depicts schematically LTE cell-specific reference signals for a dual transmitter (2-Tx) antenna-system and normal cyclic prefix;

FIG. 7 depicts schematically LTE cell-specific reference signals for a quad transmitter (4-Tx) antenna-system and normal cyclic prefix;

FIG. 8 depicts schematically a frame structure for a frame according to the fifth generation new radio (5G NR or 5G NR) frame structure;

FIG. 9 depicts schematically 5G NR frequency domain channel configuration for a wireless network operating according to the 5G NR standard;

FIG. 10 depicts location information and channel ranges returned from a database of cell tower locations for a defined cell tower (“Willowdale”);

FIG. 11 depicts a process flow for configuring a wireless transmitter forming part of a wireless transceiver according to an embodiment of the invention; and

FIG. 12 depicts a process flow for configuring a wireless transmitter forming part of a wireless transceiver according to an embodiment of the invention;

FIG. 13 depicts a process flow for configuring a wireless transmitter forming part of a wireless transceiver according to an embodiment of the invention;

FIG. 14 depicts noise power measurement results of a bandpass filter for a base transceiver station (BTS) at 4 and 2 channel scans respectively for an azimuth of 148 degrees; and

FIG. 15 depicts noise power measurement results of a bandpass filter for the BTS at 4 and 2 channel scans respectively at an azimuth of 334 degrees.

### DETAILED DESCRIPTION

The present invention is directed to wireless networks and more particularly to methods, processes and systems for configuring wireless devices within wireless networks to enhance network performance.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “wireless standard” as used herein and throughout this disclosure, refer to, but is not limited to, a standard for transmitting signals and/or data through electromagnetic radiation which may be optical, radio frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella.

“Long Term Evolution” (LTE) as used herein and throughout this disclosure, generally refers to, but is not limited to, a standard for wireless broadband communication for mobile devices and data terminals, based on the Global System for Mobile Communications (GSM)/Enhanced Data rates for GSM Evolution (EDGE) standard and/or the Universal Mobile Telecommunications System (UMTS)/High Speed Packet Access (HSPA) standards.

“Fifth Generation New Radio” (5G NR or 5G NR) as used herein and throughout this disclosure, generally refers to, but is not limited to, radio access technology (RAT) developed by 3GPP for the 5G (fifth generation) mobile network. 5G NR being designed to provide a global standard for the air interface of fifth generation (5G) networks and in common with fourth generation (4G) LTE exploits orthogonal frequency-division multiplexing (OFDM)

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “user” as used herein may refer to, but is not limited to, an individual or group of individuals. This includes, private individuals, employees of organizations and / or enterprises, members of community organizations, members of charity organizations, men, women and children. In its broadest sense the user may further include, but not be limited to, mechanical systems, robotic systems, android systems, etc. that may be characterised by an ability to exploit one or more embodiments of the invention.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

A “portable electronic device” (PED) as used herein and throughout this disclosure, refers to a wireless device used for communications and other applications that requires a battery or other independent form of energy for power. This includes, but is not limited to, such as a cellular telephone, smartphone, personal digital assistant (PDA), portable computer, pager, portable multimedia player, portable gaming console, laptop computer, tablet computer, a wearable device and an electronic reader. Within the context of wireless network infrastructure a portable electronic device may include, but is not limited to, a wireless network interface card, a wireless router, a mobile wireless base station, a mobile radio mast, and a mobile wireless cellular tower (cell tower), and one or more mobile antennae coupled to one or more wireless transceivers.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player. Within the context of wireless network infrastructure a fixed electronic device may include, but is not limited to, a wireless base station, a base station, a wireless cell tower, a cell tower, a radio mast, and one or more antennae coupled to one or more wireless transceivers.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein, and throughout this disclosure, refers to a computer and/or microprocessor readable data file comprising data relating to settings and/or limits of an adult device. Such profiles may be established by a manufacturer/supplier/provider of a device, service, etc. or they may be established by a user through a user interface for a device, a service or a PED/FED in communication with a device, another device, a server or a service provider etc.

A “computer file” (commonly known as a file) as used herein, and throughout this disclosure, refers to a computer resource for recording data discretely in a computer storage device, this data being electronic content. A file may be defined by one of different types of computer files, designed for different purposes. A file may be designed to store electronic content such as a written message, a video, a computer program, or a wide variety of other kinds of data. Some types of files can store several types of information at once. A file can be opened, read, modified, copied, and closed with one or more software applications an arbitrary number of times. Typically, files are organized in a file system which can be used on numerous different types of storage device exploiting different kinds of media which keeps track of where the files are located on the storage device(s) and enables user access. The format of a file is defined by its content since a file is solely a container for data, although, on some platforms the format is usually indicated by its filename extension, specifying the rules for how the bytes must be organized and interpreted meaningfully. For example, the bytes of a plain text file are associated with either ASCII or UTF-8 characters, while the bytes of image, video, and audio files are interpreted otherwise. Some file types also allocate a few bytes for metadata, which allows a file to carry some basic information about itself.

“Metadata” as used herein, and throughout this disclosure, refers to information stored as data that provides information about other data. Many distinct types of metadata exist, including but not limited to, descriptive metadata, structural metadata, administrative metadata, reference metadata and statistical metadata. Descriptive metadata may describe a resource for purposes such as discovery and identification and may include, but not be limited to, elements such as title, abstract, author, and keywords. Structural metadata relates to containers of data and indicates how compound objects are assembled and may include, but not be limited to, how pages are ordered to form chapters, and typically describes the types, versions, relationships and other characteristics of digital materials. Administrative metadata may provide information employed in managing a resource and may include, but not be limited to, when and how it was created, file type, technical information, and who can access it. Reference metadata may describe the contents and quality of statistical data whereas statistical metadata may also describe processes that collect, process, or produce statistical data. Statistical metadata may also be referred to as process data.

An “artificial intelligence system” (referred to hereafter as artificial intelligence, AI) as used herein, and throughout disclosure, refers to machine intelligence or machine learning in contrast to natural intelligence. An AI may refer to analytical, human inspired, or humanized artificial intelligence. An AI may refer to the use of one or more machine learning algorithms and/or processes. An AI may employ one or more of an artificial network, decision trees, support vector machines, Bayesian networks, and genetic algorithms. An AI may employ a training model or federated learning.

“Machine Learning” (ML) or more specifically machine learning processes as used herein refers to, but is not limited, to programs, algorithms or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. A machine learning algorithm or machining learning process as employed by an AI may include, but not be limited to, supervised learning, unsupervised learning, cluster analysis, reinforcement learning, feature learning, sparse dictionary learning, anomaly detection, association rule learning, inductive logic programming.

“Customer-Premises Equipment” (CPE, also referred to as customer-provided equipment) (CPE) as used herein, and throughout disclosure, refers to any terminal and associated equipment located at a subscriber's premises and connected with a carrier's telecommunication circuit at a demarcation point (“demarc”). The demarc is typically a point established in a building or complex to separate customer equipment from the equipment located in either the distribution infrastructure or central office of the communications service provider. CPE may include, but not be limited, generally refers to devices such as routers, network switches, residential gateways (RG), set-top boxes, fixed mobile convergence products, home networking adapters and Internet access gateways that enable consumers to access providers' communication services and distribute them in a residence or enterprise with a local area network (LAN). However, in a generalized context a CPE may include wireless devices, e.g. an FED or PED, connected to a base station where the demarcation (demarc) is the over-the-air interface.

Within the context of this specification a fixed wireless device or a portable wireless device may include, but not be limited to, a fixed wireless client station, an element of consumer premise equipment (CPE), or an element of user equipment (UE) as are known in the art. A wireless device, fixed or portable, may include a base transceiver station (BTS) as known in the art. Within the context of embodiments of the invention based upon or exploiting Long Term Evolution (LTE) an element of UE may be mobile, portable or fixed.

Wireless networks provide communications between electronic devices that be either local to one another, within a common region or country, or be internationally distributed. Whilst wireless networks have become a ubiquitous aspect of the telecommunications infrastructure offering benefits such as high connectivity, high upload and download speeds and low latency these benefits are typically evident in urban environments. The provisioning of wireless networks in rural environments, however, is still a significant issue. This arises from a variety of factors including reduced densities of users, reduced infrastructure such as cellular network towers (cell towers), and increase distances coupled with seasonal variations such as inclement weather in the winter, leaves on trees during the summer etc.

These factors relevant to the rural broadband case are compounded by regulatory restrictions that define limits on spectrum availability, allowable transmit power levels and spectral mask requirements which limit performance. Accordingly, it would be beneficial to provide wireless networks and more particularly wireless devices within the wireless network to provide increased connectivity and performance within rural wireless networks whilst maintaining compliance with the applicable local, region and national requirements as defined in the applicable specifications.

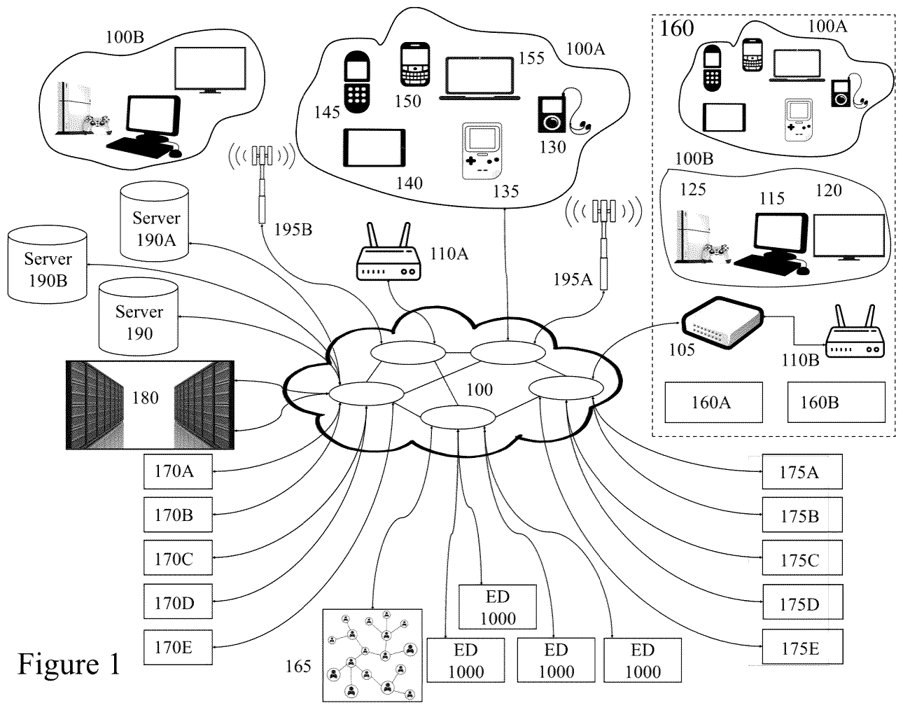

Referring to FIG. 1 there is depicted a Network 100 within which embodiments of the invention may be employed supporting Dynamic Wireless (DW) Systems, Applications and Platforms (DW-SAPs) according to embodiments of the invention. Such DW-SAPs, for example, supporting multiple communication channels, dynamic filtering, etc. As shown first and second user groups 100A and 100B respectively interface to a telecommunications Network 100. Within the representative telecommunication architecture, a remote central exchange 180 communicates with the remainder of a telecommunication service providers network via the Network 100 which may include for example long-haul OC-48/OC-192 backbone elements, an OC-48 wide area network (WAN), a Passive Optical Network, and a Wireless Link. The central exchange 180 is connected via the Network 100 to local, regional, and international exchanges (not shown for clarity) and therein through Network 100 to first and second cellular APs 195A and 195B respectively which provide Wi-Fi cells for first and second user groups 100A and 100B respectively. Also connected to the Network 100 are first and second Wi-Fi nodes 110A and 110B, the latter of which being coupled to Network 100 via router 105. Second Wi-Fi node 110B is associated with Service Provider 160 comprising other first and second user groups 100A and 100B.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the embodiment to first and second user groups 100A and 100B. Alternatively the first and second user groups 100A and 100B may be geographically disparate and access the Network 100 through multiple APs, not shown for clarity, distributed geographically by the network operator or operators. First cellular AP 195A as show provides coverage to first user group 100A and environment 170, which comprises second user group 100B as well as first user group 100A.

Accordingly, the first and second user groups 100A and 100B may according to their particular communications interfaces communicate to the Network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and/or Bluetooth as well in an ad-hoc manner.

Also connected to the Network 100 are Social Networks (SOCNETS) 165, first and second service providers 170A and 170B respectively, first and second third party service providers 170C and 170D respectively, and a user 170E. Also connected to the Network 100 are first and second enterprises 175A and 175B respectively, first and second organizations 175C and 175D respectively, and a government entity 175E. Also depicted are first and second servers 190A and 190B may host according to embodiments of the inventions multiple services associated with a provider of Dynamic Wireless (DW) Systems, Applications and Platforms (DW-SAPs); a provider of a SOCNET or Social Media (SOME) exploiting DW-SAP features; a provider of a SOCNET and/or SOME not exploiting DW-SAP features; a provider of services to PEDS and/or FEDS; a provider of one or more aspects of wired and/or wireless communications; a Service Provider 160 exploiting DW-SAP features; license databases; content databases; image databases; content libraries; customer databases; websites; and software applications for download to or access by FEDs and/or PEDs exploiting and/or hosting DW-SAP features. First and second primary content servers 190A and 190B may also host for example other Internet services such as a search engine, financial services, third party applications and other Internet based services.

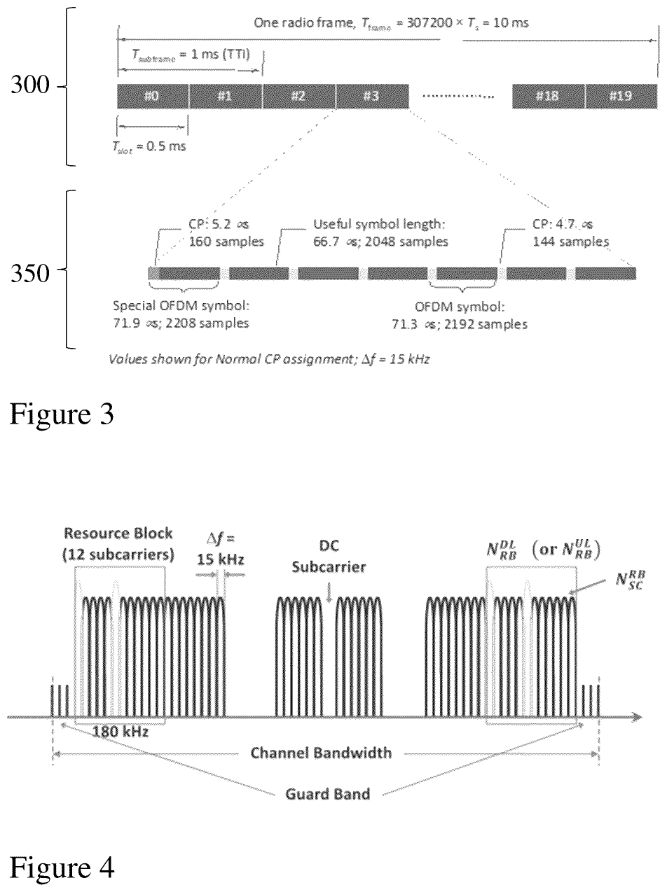

Also depicted in FIG. 1 are Electronic Devices (EDs) 100 according to embodiments of the invention such as described and depicted below in respect of FIGS. 3A to XXX. As depicted in FIG. 1 the EDs 100 communicate directly to the Network 100. The EDs 100 may communicate to the Network 100 through one or more wireless or wired interfaces included those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, a consumer and/or customer (CONCUS) may exploit a PED and/or FED within an Enterprise 160, for example, and access one of the first or second primary content servers 190A and 190B respectively to perform an operation such as accessing/downloading an application which provides DW-SAP features according to embodiments of the invention; execute an application already installed providing DW-SAP features; execute a web based application providing DW-SAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A. It would also be evident that a CONCUS may, via exploiting Network 100 communicate via telephone, fax, email, SMS, social media, etc.

Within embodiments of the invention described and depicted below a cellular AP, e.g. first cellular AP 195A, may comprise a BTS unit which connects to one or more CPE elements and therein a wired or wireless switch, such as first Wi-Fi node 110A for example. This CPE then connects to user group devices. Within the embodiments of the invention described below the CPE connects to the BTS using a wireless link, e.g. a wireless link forming part of Network 100. The CPE may connect to the first Wi-Fi node 110A unit via am optical fiber interface (e.g., a fibre optic cable), an electrical interface (e.g., an Ethernet cable) or wirelessly (e.g., Bluetooth, Wi-Fi, etc.).

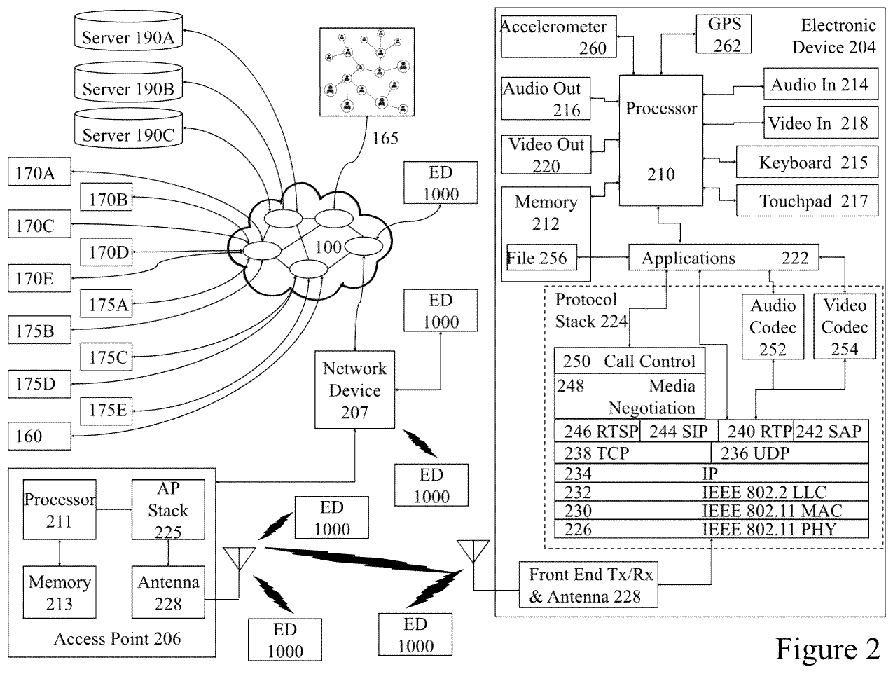

Now referring to FIG. 2 there is depicted an Electronic Device 204 and network access point 207 supporting DW-SAP features according to embodiments of the invention. Electronic Device 204 may, for example, be a PED and/or FED and may include additional elements above and beyond those described and depicted. Also depicted within the Electronic Device 204 is the protocol architecture as part of a simplified functional diagram of a system 200 that includes an Electronic Device 204, such as a smartphone 155 for example, an access point (AP) 206, such as first Wi-Fi node 110A for example, a cellular network access point, such as first cellular AP 195A for example, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to Network 100 and therein Social Networks (SOCNETS) 165, first and second service providers 170A and 170B respectively, first and second third party service providers 170C and 170D respectively, a user 170E, first and second enterprises 175A and 175B respectively, first and second organizations 175C and 175D respectively, and a government entity 175E.

The Electronic Device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 204 may include an audio input element 214, for example a microphone, and an audio output element 216, for example, a speaker, coupled to any of processors 210. Electronic Device 204 may include a video input element 218, for example, a video camera or camera, and a video output element 220, for example an LCD display, coupled to any of processors 210. Electronic Device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the Electronic Device 204. The one or more applications 222 that are typically stored in memory 212 and are executable by any combination of processors 210. Electronic Device 204 also includes accelerometer 260 providing three-dimensional motion input to the process 210 and GPS 262 which provides geographical location information to processor 210.

Electronic Device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the Electronic Device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by Electronic Device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted in FIG. 2 are Electronic Devices (EDs) 100 according to embodiments of the invention such as described and depicted below in respect of FIGS. 3 to XXX. As depicted in FIG. 2 an EDs 100 may communicate directly to the Network 100. Other EDs 100 may communicate to the Network Device 207, Access Point 206, and Electronic Device 204. Some IREDs 100 may communicate to other IREDs 100 directly. Within FIG. 2 the EDs 100 coupled to the Network 100 and Network Device 207 communicate via wired interfaces. The IREDs 100 coupled to the Access Point 206 and Electronic Device 204 communicate via wireless interfaces. Each IRED 100 may communicate to another electronic device, e.g. Access Point 206, Electronic Device 204 and Network Device 207, or a network, e.g. Network 100. Each ED 100 may support one or more wireless or wired interfaces including those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 2 depicts an Electronic Device 204, e.g. a PED, wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D via the Network 100 using the electronic device or within either the access point 206 or network device 207 wherein details of the transaction are then coupled to the Network 100 and stored within remote servers.

As outlined previously it would be beneficial to provide wireless networks and more particularly wireless devices within the wireless network to provide increased connectivity and performance within rural wireless networks whilst maintaining compliance with the applicable local, region and national requirements as defined in the applicable specifications. Accordingly, the inventors have established methods and processes for use by wireless devices and systems for configuring wireless devices within wireless networks to enhance network performance, particularly in respect of deployments in rural environments, although the processes and methods may be applied to other wireless systems.

Accordingly, as outlined below with respect to embodiments of the invention a wireless device may initially configure, periodically reconfigure, dynamically reconfigure, reconfigure under network command etc. to establish operation upon one or more channels. Within such initial configurations, periodic reconfigurations, and dynamic reconfigurations the wireless device may exploit channel configuration, frame structure and reference signals for assessing channel quality and interference. Within this portion of the specification an overview of LTE and 5G NR channel configurations, frame structures and reference signals is provided for a reader of the specification to understand how an algorithm or algorithms according to embodiments of the invention may select a specific frequency carrier from a set of available carriers.

Within embodiments of the invention an algorithm or algorithms may select a specific frequency carrier from a set of available carriers based upon one or more defined conditions and/or defined thresholds which are based upon initial defaults of the installed software for the wireless device or are these initial defaults modified based upon subsequent operation of the wireless device and/or updates from the wireless network which may include, but not be limited to, software updates, software upgrades, compliance updates, regulatory updates, network configuration updates and network updates.

Within other embodiments of the invention rather than fixed or periodically updated defaults for the one or more defined conditions and/or defined thresholds the wireless device may exploit one or more machine learning (ML) algorithms and/or artificial intelligence (AI) algorithms wherein the wireless device automatically adjusts the defaults in dependence upon processing of acquired data relating to wireless links supported by the wireless device with the one or more ML algorithms and/or one or more AI algorithms.

Whilst the following description relates to LTE and 5G NR it would be evident that the underlying concepts, techniques, etc. of embodiments of the invention may be applied to other wireless protocols, wireless standards etc.

Whilst the embodiments of the invention are described within the following description based upon analysis of the performance of one or more wireless downlinks, i.e. based upon wireless signals received by the wireless device from one or other wireless devices (hereinafter downlinks), it would be evident to a person of skill in the art that the embodiments of the invention may also support configuration of a wireless device based upon data relating to the performance of one or more wireless uplinks, i.e. based upon wireless signals received by one or more other wireless device from the wireless device (hereinafter uplinks) discretely or in combination with data relating to downlinks. Where data relating to both uplinks and downlinks is employed the other wireless devices for the uplinks and the downlinks may be same or they may be different. Further, as outlined below different modulation formats may be employed on the uplinks and downlinks concurrently to enable operation within the wireless and physical environments.

LTE and 5G NR share many common physical layer characteristics, such as they both implement orthogonal frequency-division multiple access (OFDMA) in the downlink. OFDMA being a multi-user version of the OFDM digital modulation scheme where multiple access is achieved by assigning subsets of subcarriers to individual users thereby allowing transmission from several users. However, there are subtle differences in the implementation of these two technologies which are highlighted below.

### LTE Frame Structure

LTE Time Domain Structure: FIG. 3 depicts schematically a frame structure for a Frame 300 according to the Long-Term Evolution (LTE) standard for wireless broadband communications. Each LTE frame is 10 ms long and is divided into 10×1 ms subframes. Each subframe contains two 0.5 ms slots each of which has 7 OFDM symbols. The structure of a subframe being depicted in Sub-Frame 350. Within the following description emphasis is on the normal cyclic prefix implementation, which is standard for most LTE equipment. There is an extended cyclic prefix where the parameters change; however, this is not described or depicted within this specification although it would be evident to one of skill in the art that embodiments of the invention support either prefix implementation.

LTE Frequency-Domain Structure: FIG. 4 depicts schematically the LTE frequency domain channel configuration for a wireless network operating according to the LTE standard. In the frequency domain, an LTE carrier consists of several 15 kHz orthogonal subcarriers. The number of subcarriers is scalable depending on the channel bandwidth. The subcarriers could carry data or they could be used for the guard band as a buffer against interference with adjacent channels as shown in FIG. 2.

A group of 12 subcarriers forms a resource block (RB). Table 1 shows the details of the frequency domain configuration including the transmission bandwidth and guard bands. Out of the 6 possible channel bandwidths available in LTE, 5 MHz, 10 MHz and 20 MHz are the most commonly commercially deployed configurations.

TABLE 1
LTE Channel Configuration Specifications

| | | | | | | |
|---|---|---|---|---|---|---|
| Channel Bandwidth | 1.4 | 3 | 5 | 10 | 15 | 20 |
| (MHz) | | | | | | |
| Total number of | 128 | 256 | 512 | 1024 | 1536 | 2048 |
| subcarriers | | | | | | |
| Occupied | 72 | 180 | 300 | 600 | 900 | 1200 |
| subcarriers | | | | | | |
| Guard subcarriers | 55 | 75 | 211 | 423 | 635 | 847 |
| Number of resource | 6 | 15 | 25 | 50 | 75 | 100 |
| blocks | | | | | | |
| Occupied channel | 1.125 | 2.7 | 4.5 | 9.0 | 13.5 | 18.0 |
| bandwidth (MHz) | | | | | | |
| Guard band (MHz) | 0.275 | 0.3 | 0.5 | 1 | 1.5 | 2 |
| Bandwidth | 77.1% | 90% | 90% | 90% | 90% | 90% |
| efficiency | | | | | | |

LTE Channel Raster: The channel raster defines a subset of RF reference frequencies that can be used to identify the RF channel position in the downlink and uplink. For each operating band, a subset of frequencies from the global frequency raster are applicable for that band and forms a channel raster with a granularity, ΔFRaster. Within LTE, this channel raster is ΔFRaster=100 kHz. The carrier centre frequency must be an integer multiple of 100 kHz.

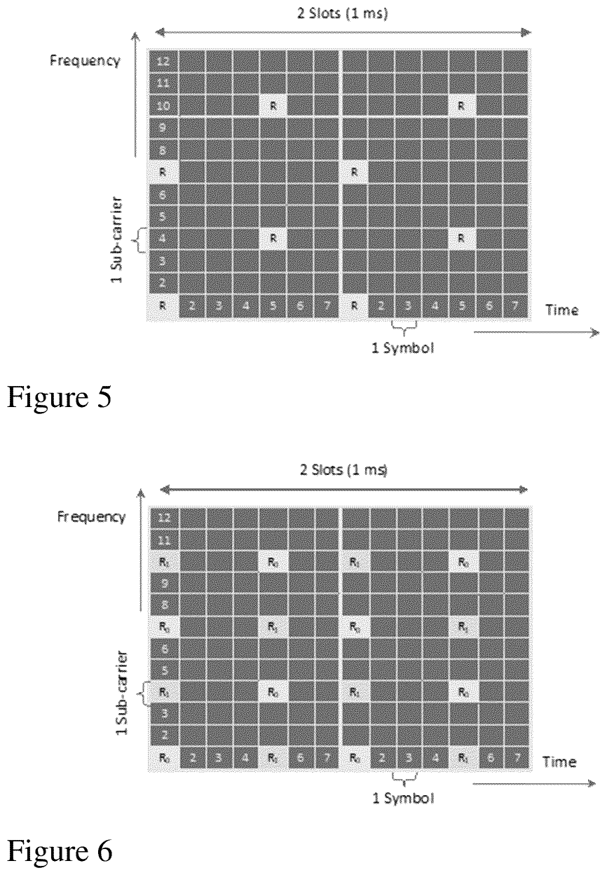

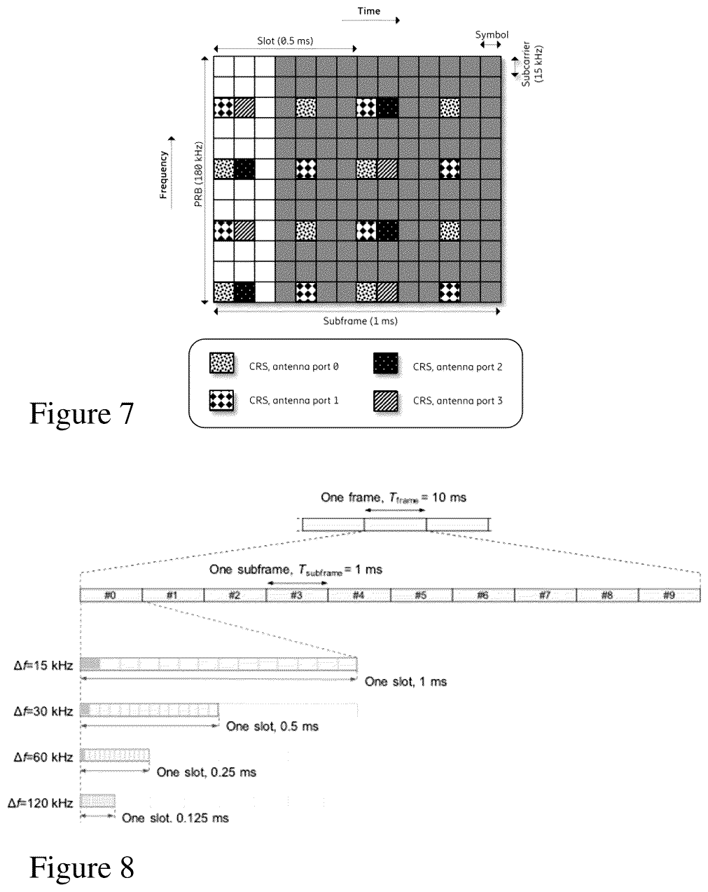

LTE Reference Signals: LTE features a number of control and reference signals. Of these, for the purpose of channel estimation and channel quality assessment in interference conditions, LTE uses cell-specific reference signals (CRS). The CRS is placed in specific subcarriers in the time-frequency map. These locations vary according to the number of antennas as shown in FIGS. 4 to 7 for 1 antenna (1-Tx), 2 antenna (2-Tx) and 4 antenna (4-Tx) systems respectively. These being for the normal cyclic prefix. Today, the 2-Tx is commonly deployed commercially along with the 4-Tx system which is popular in urban deployments.

A wireless device calculates the signal-to-noise ratio (SINR) through a Reference Signal Received Power (RSRP) and a noise (or interference) strength, and finds the corresponding channel quality indictor (CQI) which the wireless device reports to a base station with which the wireless device is associated. Accordingly, the downlink data is acquired, processed and communicated through the uplink (or another network) to the base station. The CQI denotes the highest data rate, or modulation and code rate that the wireless device, e.g. a FED, PED, wearable device etc., will successfully support.

### 5G NR Frame Structure

5G NR Time Domain Structure: 5G NR introduces additional flexibility into the frame structure to meet various requirements such as lower latency. FIG. 8 depicts schematically the frame structure for a frame according to the 5G NR frame structure. Whilst the frames are still 10 ms long and include 10×1 ms subframes, 5G NR supports different slot lengths. This is because in the frequency domain 5G NR supports multiple sub-carrier spacing (SCS) as described below in FIG. 10 and Table 2 where reference should be made back to LTE which only uses a fixed 15 kHz subcarrier spacing. A time slot contains 14 OFDM symbols, which is different from the definition of a time slot in LTE where it contains only 7 symbols. Accordingly, as evident in FIG. 8 a time slot with Δf=15 kHz is 1 ms long, whereas when Δf=30 kHz, 60 kHz, or 120 kHz then the time slots are 0.5 ms, 0.25 ms and 0.125 ms long respectively.

TABLE 2
5GNR Time-Domain Frame Structure Specifications

| | Subcarrier | Number of | Number of | Number of |
|---|---|---|---|---|
| | Spacing | Symbols | Slots per | Slots per |
| Numerology | (kHz) | per Slot | frame | Sub-Frame |
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |

With respect to deployments then numerologies 0-2 are employed within systems operating within a first frequency band from 410 MHz to 7.125 GHz (FR1) whilst numerologies 2-4 are employed within systems operating within a second frequency band from 24.250 GHz to 71.000 GHz (FR2) (i.e. within the millimeter-wave band).

5G NR Frequency Domain Structure: 5G NR supports multiple subcarrier spacings as evident from Table 2 at 15 kHz, 30 kHz and 60 kHz within the first frequency band (FR1) and 60 kHz, 120 kHz and 240 kHz in the second higher frequency band (FR2). However, typically wireless devices operating below 1 GHz primarily use the 15 kHz channel spacing whilst at medium frequencies, such as 3.5 GHz, wireless devices primarily use subcarrier spacings of 30 kHz or 60 kHz.

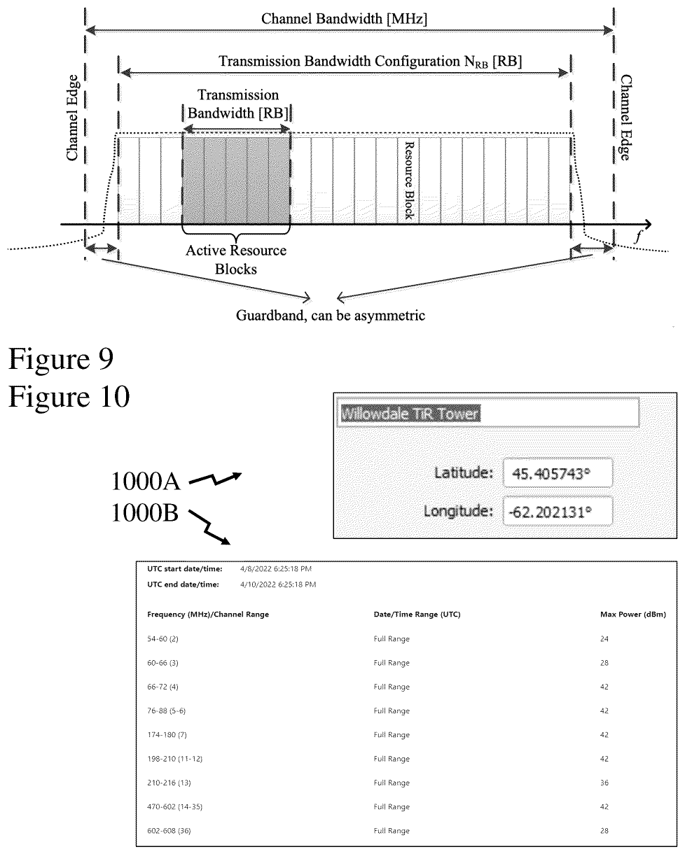

A resource block includes 12 subcarriers, similar to LTE. FIG. 9 shows the channel configuration. Tables 3 and 5 show the transmission band with a number of resource blocks (RBs), or 180 kHz, for FR1 and FR2, respectively. Tables 4 and 6 show the minimum guard band in kHz for FR1 and FR2, respectively.

TABLE 3
Transmission Bandwidth in Number of RBs for FR1

| | SCS/BW (MHz) | | | | | | | | | | | | |
|---|---|---|---|---|---|---|---|---|---|---|---|---|---|
| | 5 | 10 | 15 | 20 | 25 | 30 | 40 | 50 | 60 | 70 | 80 | 90 | 100 |
| 15 kHz | 25 | 52 | 79 | 106 | 133 | 160 | 216 | 270 | NA | NA | NA | NA | NA |
| 30 kHz | 11 | 24 | 38 | 51 | 65 | 78 | 106 | 133 | 162 | 189 | 217 | 245 | 273 |
| 60 kHz | NA | 11 | 18 | 24 | 31 | 38 | 51 | 65 | 79 | 93 | 107 | 121 | 135 |

TABLE 4
Minimum Guard Band in kHz for FR1

| | SCS/BW (MHz) | | | | | | |
|---|---|---|---|---|---|---|---|
| | 5 | 10 | 15 | 20 | 25 | 30 | 40 |
| 15 kHz | 242.5 | 312.5 | 382.5 | 452.5 | 522.5 | 592.5 | 552.5 |
| 30 kHz | 505 | 665 | 645 | 805 | 785 | 945 | 905 |
| 60 kHz | NA | 1010 | 990 | 1330 | 1310 | 1290 | 1610 |

SCS/BW (MHz)

| | 50 | 60 | 70 | 80 | 90 | 100 |
|---|---|---|---|---|---|---|
| 15 kHz | 692.5 | NA | NA | NA | NA | NA |
| 30 kHz | 1045 | 825 | 965 | 925 | 885 | 845 |
| 60 kHz | 1570 | 1530 | 1490 | 1450 | 1410 | 1370 |

TABLE 5
Transmission Bandwidth in Number of RBs for FR2

Bandwidth

| SCS | 50 MHz | 100 MHz | 200 MHz | 400 MHz |
|---|---|---|---|---|
| 60 kHz | 66 | 132 | 264 | NA |
| 120 kHz | 32 | 66 | 132 | 264 |

TABLE 6
Minimum Guard Band in kHz for FR2

Bandwidth

| SCS | 50 MHz | 100 MHz | 200 MHz | 400 MHz |
|---|---|---|---|---|
| 60 kHz | 66 | 132 | 264 | NA |
| 120 kHz | 32 | 66 | 132 | 264 |

Accordingly, the channel bandwidth in 5G NR is given by Equation (1) below.

Channel Bandwidth=Number of RBs×Number of Subcarriers per RB×SCS+Minimum Guard band×2 (1)

For example, given a 20 MHz channel and 15 kHz subcarrier, the channel bandwidth (BW) is given by Equation (2)

BW=106×12×15+452.5×2=19,080+905=19,985 kHz (2)

Accordingly, 5G NR is more efficient than LTE in using the channel bandwidth. For comparison, for a 20 MHz channel, LTE transmission bandwidth is 18 MHz (90%) versus 19.08 MHz (95.4%) for 5G NR. Table 7 presents channel utilization for LTE and 5G NR.

TABLE 7
Comparison between LTE and 5GNR Channel
Utilization for 15 kHz Subcarrier Spacing

| | 5 MHz | | 10 MHz | | 20 MHz | |
|---|---|---|---|---|---|---|
| | LTE | 5GNR | LTE | 5GNR | LTE | 5GNR |
| Number of Resource | 25 | 25 | 50 | 52 | 100 | 106 |
| Blocks | | | | | | |
| Subcarrier Spacing | 15 | 15 | 15 | 15 | 15 | 15 |
| (kHz) | | | | | | |
| Transmission | 4.5 | 4.5 | 9 | 9.36 | 18 | 19.08 |
| Bandwidth (MHz) | | | | | | |
| Downlink Bandwidth | 90% | 90% | 90% | 93.6% | 90% | 95.4% |
| Efficiency | | | | | | |

5G NR Channel Raster: The channel raster for 5G NR FR1 frequencies is 100 kHz except for the exceptions identified in Table 8.

TABLE 8
ΔFRaster Exceptions

| | Frequency | | |
|---|---|---|---|
| Band | Range (MHz) | ΔFRaster | Comments |
| N41 | 2496-2690 | 15 kHz or | US Broadband Radio Service |
| | | 30 kHz | (BRS) & Education Broadband |
| | | | Service (EBS) |
| N48 | 3550-3700 | 15 kHz or | Citizens Broadband Radio |
| | | 30 kHz | Service (US) |
| N77 | 3300-4200 | 15 kHz or | Covers 3.9 GHz band for |
| | | 30 kHz | private networks in Canada |
| N78 | 3300-3800 | 15 kHz or | C-Band |
| | | 30 kHz | |
| N46 | 5150-5925 | 15 kHz | U-NII-1-4 |

5G NR Reference Signals for Channel Estimation: There are important differences between reference signals in LTE and 5G NR which seeks to be more efficient in using reference signals to maximize throughput. A general overview of the differences include, but not limited to, the following.

Within 5G NR there is no Cell Specific Reference Signal (CRS). Instead, 5G NR relies on a Channel State Information Reference Signal (CSI-RS) which is used in the downlink to estimate the channel and report channel quality information back to the 5G base station for CSI acquisition and beam management.

In the uplink, 5G NR uses the Sounding Reference Signal (SRS) to help the gNB obtain the channel state information (CSI) for each user. The SRS is a wideband view of the uplink channel with a comb-like structure that interleaves the reference resource elements (REs) every 2 or 4 Res.

5G NR introduces additional reference signals such as:
Demodulation Reference Signal (DMRS) which is specific to each downlink (DL) or uplink (UL) logical channel e.g. Physical Broadcast Channel (PBCH), Physical Downlink Shared Channel (PDSCH), etc.
Phase Tracking Reference Signal (PTRS) which tracks the phase of the local oscillator at the transmitter and receiver to suppress phase noise, particularly for millimeter wave bands.

The wireless device employs the Channel State Information Reference Signal (CSI-RS) to measure the quality of the downlink channel and report this in the uplink. These reports include information on the radio channel that the base station requires in order to establish the appropriate modulation, code rate, beamforming and MIMO order. A 5G NR base stations uses the CSI-RS for the following activities:
Beam Management: Channel Quality Indicator (CQI), Rank Indicator (RI), and Precoding Matrix Indicator (PMI) measurements. These measurements are sent by wireless devices to base stations in order to determine and estimate the correct direction of beams.
Connected Mode Mobility Management: For calculating Reference Signal Received Power (RSRP), Reference Signal Received Quality (RSRQ), RS Signal to Interference and Noise Ratio (SINR).
Radio Link Failure Detection: To check if a channel is out of synchronization or in synchronization as well as for beam failure detection and recovery, time and frequency synchronization (using Tracking Reference Signals) and coordination and multi-point transmission.

Within 5G NR, the reference signals are transmitted only when necessary whereas within LTE reference signals are constantly exchanged to manage the link. This makes 5G NR a more efficient protocol than LTE because more of the resource elements can be assigned for data transfer. There are other benefits to using CSI-RS as defined in 5G NR such as different sets of CSI-RSs can be allocated to different wireless devices (also known as user equipment) to form directional beams.

Algorithm: The generally common structures of LTE and 5G NR allow the inventor to establish an algorithm to operate a base station upon a best frequency channel available in a frequency band and to improve the operating performance of the wireless device.

Within a first step of an algorithm according to an embodiment of the invention determines a subset of the available frequency bandwidths. For example, this may be 5 MHz, 10 MHz or 20 MHz for example with LTE or larger up to 100 MHz for example with 5G NR. Once the frequency range of operation has been established then a second step within an algorithm according to an embodiment of the invention is to position the carrier center frequency within this operating frequency range. The carrier center frequency can be set in increments of the channel raster for LTE or 5G NR in the specific brand of interest. The channel raster is typically 100 kHz for most frequency bands.

The selection of the carrier centre frequency may be further selected to maximize the performance of the communication link. The determination may be based upon initial measurements that include, for example, the adjacent channel interference level(s) or more specifically the adjacent channel leakage ratio (ACLR). Further, the ACLR value sets or impacts the transmit power that a wireless device can operate at within the process of its certification. Accordingly, ACLR is not just about the interference risk within band as through its impact on the maximum transmission power it can directly impact link quality even in the absence of any interference to other channels factoring into this determination. Further, measurements may be deployed to establish the center frequency selection including, but not limited to, measurements and/or parameters for signal quality measured and reported by the LTE or 5G NR base station.

Both LTE and 5G NR over-the-air interface protocols include reference signals that the base station uses to determine the link quality for devices it serves. Depending on the link conditions measured by these reference signals, the base station adjusts certain parameters, such as modulation and coding rate to optimize its resource allocation. Parameters measured by such reference signals would be factored into the algorithm to further optimize the frequency channel selection.

Tables 9 and 10 provides some parameters that may be employed in channel selection optimization for a wireless device employing a protocol/algorithm according to an embodiment of the invention.

TABLE 9
Exemplary 5G NR Parameters for Channel Selection

| Reference | | |
|---|---|---|
| Signal | Parameter | Description |
| CSI-RS | CSI-RSRP | CSI reference signal received power (CSI-RSRP), is defined as |
| | | the linear average over the power contributions (in [W]) of the |
| | | resource elements of the antenna port(s) that carry CSI reference |
| | | signals configured for RSRP measurements within the considered |
| | | measurement frequency bandwidth in the configured CSI-RS |
| | | occasions. |
| CSI-RS | CSI-RSRQ | CSI reference signal received quality (CSI-RSRQ) is defined as |
| | | the ratio of N × CSI-RSRP to CSI-RSSI, where N is the number of |
| | | resource blocks in the CSI-RSSI measurement bandwidth. |
| SRS | SRS-RSRP | SRS reference signal received power (SRS-RSRP) is defined as |
| | | linear average of the power contributions (in [W]) of the resource |
| | | elements carrying sounding reference signals (SRS). |
| SS | SRS-RSRP | SRS reference signal received power (SRS-RSRP) is defined as |
| | | linear average of the power contributions (in [W]) of the resource |
| | | elements carrying sounding reference signals (SRS). |
| SS | SS-RSRQ | Secondary synchronization signal reference signal received |
| | | quality (SS-RSRQ) is defined as the ratio of N × SS-RSRP/NR |
| | | carrier RSSI, where N is the number of resource blocks in the NR |
| | | carrier RSSI measurement bandwidth. |

TABLE 10
Exemplary LTE Parameters for Channel Selection

| Reference | | |
|---|---|---|
| Signal | Parameter | Description |
| CRS | RSRP | Reference Signal Received Power (RSRP), is defined as the linear |
| | | average over the power contributions (in [W]) of the resource |
| | | elements that carry cell-specific reference signals within the |
| | | considered measurement frequency bandwidth. |
| CRS | RSSI | Received Signal Strength Indicator (RSSI) measures the average |
| | | total received power observed only in OFDM symbols containing |
| | | reference symbols for and antenna port (i.e., OFDM symbol 0 & |
| | | 4 in a slot for antenna port 0) in the measurement bandwidth over |
| | | N resource blocks. |
| CRS | RSRQ | Reference Signal Received Quality (RSRQ) is defined as the ratio |
| | | N × RSRP/(E-UTRA carrier RSSI), where N is the number of |
| | | RB's of the E-UTRA carrier RSSI measurement bandwidth. The |
| | | measurements in the numerator and denominator shall be made |
| | | over the same set of resource blocks. |

As noted above a first step within an algorithm according to an embodiment of the invention is the determination of a subset of the available frequency bandwidths to operate upon after which the channel to operate upon is established. Within one methodology this first step is based upon polling a database associated with a network that stores configuration information for base stations. Accordingly, referring to FIG. 10 in first Image 1000A a base station is identified either by searching the database for its name, Willowdale TiR Tower, which is a wireless tower in Willowdale, Nova Scotia, Canada, wherein the database returns the coordinates for the wireless tower or by searching based upon coordinate wherein a nearest tower is returned. For example, a wireless installation during commissioning may establish its location using a global positioning system and register with the database. Whilst the description considers fixed wireless infrastructure it would be evident that the algorithm(s) and method(s)/process(es) may equally be applied to mobile wireless infrastructure and/or wireless infrastructure which is positioned temporarily.

The remote database also returns additional information relating to the wireless infrastructure as evident from second Image 1000B in FIG. 10. This information includes, for example, a start time/date that the returned information is valid from, a stop time/date that the returned information is valid to, and a sequence of frequencies that the wireless infrastructure can support together with limitations such as portions of the validity range and maximum output power. For example, in second Image 1000B the returned data is valid from 6:25:18 pm on Apr. 8, 2022, to 6:25:18 pm on Apr. 10, 2022. The wireless infrastructure information in second Image 1000B being reproduced in Table 11.

The content of the database for each element of wireless infrastructure may be periodically updated or it may be updated based upon discrete events such as the addition of a new element of wireless infrastructure, removal of an existing element of wireless infrastructure (for example permanently or temporarily based upon repair, failure etc.), a revision to network topology, changes to network infrastructure, changes in traffic patterns, associate devices, etc. For example, within an embodiment of the invention the database is updated daily with a start/stop time covering the next 24 hours for example.

TABLE 11
Example of Database Return for Wireless Infrastructure Location

| | | |
|---|---|---|
| Frequency (MHz)/ | | |
| Channel Range | Date/Time Range | Max. Power (dBm) |

| | | | |
|---|---|---|---|
| 54-60 | (2) | Full Range | 24 |
| 60-66 | (3) | Full Range | 28 |
| 66-72 | (4) | Full Range | 42 |
| 76-88 | (5-6) | Full Range | 42 |
| 174-180 | (7) | Full Range | 42 |
| 198-210 | (11-12) | Full Range | 42 |
| 210-216 | (13) | Full Range | 36 |
| 470-602 | (14-35) | Full Range | 42 |
| 602-608 | (36) | Full Range | 28 |

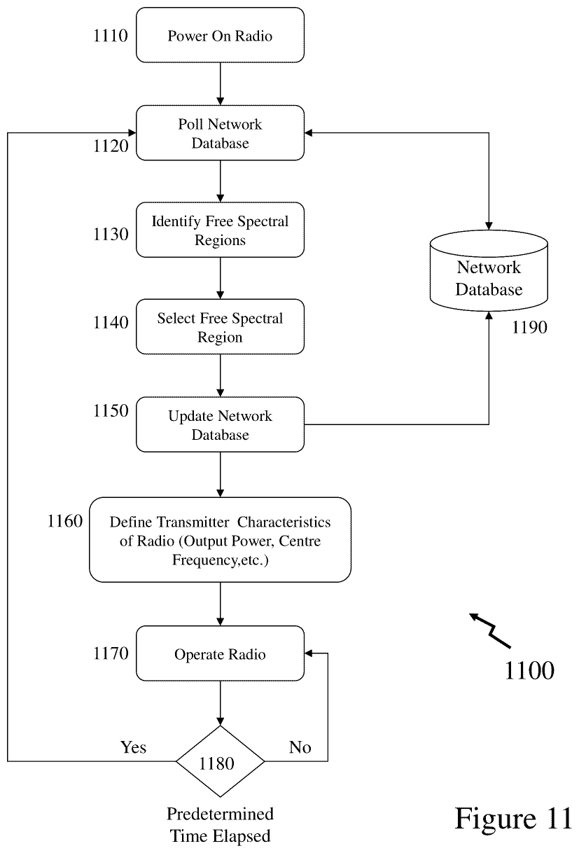

Referring to FIG. 11 there is depicted a process Flow 1100 configuring a wireless transmitter forming part of a wireless transceiver according to an embodiment of the invention. As depicted in FIG. 11 Flow 1100 comprises first to eighth steps 1110 to 1180 which are executed by an electronic device during a periodic configuration process. The Flow 1100 accesses and pushes data to a Network Database 1190. First to eighth steps 1110 to 1180 respectively comprising:
First step 1110 wherein the wireless transceiver (radio) of the electronic device is powered on wherein the process proceeds to second step 1120.
Second step 1120 wherein the radio polls the Network Database 1190 and is provided with spectrum data from the Network Database 1190 wherein the process proceeds to third step 1130.
Third step 1130 wherein the radio identifies free spectral regions within the spectral data acquired from the Network Database 1190 wherein the process proceeds to fourth step 1140.
Fourth step 1140 wherein the radio identifies the largest free spectral region within the identified free spectral region in third step 1130 wherein the process proceeds to fifth step 1150.
Fifth step 1150 wherein the radio updates the Network Database 1190 by advising the Network Database 1190 that the radio is declaring the identified largest spectral region for its operation wherein the process proceeds to sixth step 1160.
Sixth step 1160 wherein the radio defines the transmitter characteristics to be employed whilst transmitting within the identified largest spectral region, where these characteristics may include, but not be limited to, output power and centre frequency, wherein the process proceeds to seventh step 1170.
Seventh step 1170 wherein the electronic device operates the radio according to the characteristics established in sixth step 1160 wherein the process proceeds to eighth step 1180.
Eighth step 1180 wherein the electronic device determines whether a predetermined period of time has elapsed, e.g. 24 hours, wherein upon a negative determination Flow 1100 loops back to seventh step 1170 otherwise upon a positive determination it loops back to second step 1120.

In second step 1120 a poll is defined as being performed to the Network Database 1190. More specifically, within embodiments of the invention this “polling” step is a data exchange wherein the radio (wireless device) provides, for example, its characteristic information to the database, e.g., Network Database 1190, and the database returns data relating to spectrum availability. The characteristic information relating to the radio may include, but not be limited to, data relating to one or more geolocations of the radio's intended operation, a regulatory certification number of the radio, data relating to an owner of the radio. Within embodiments of the invention the characteristic information may also include timing data relating to one or more intended times or time periods the radio is intended to operate within. Within embodiments of the invention where the radio is a mobile radio (e.g., a mobile wireless device or PED) the data relating to one or more geolocations of the radio's intended operation may be data defining a geofence.

Within the context of this specification reference to a radio declaring or a declaration by a radio relates to the radio's intent to establish registration with a database that the radio intends to operate within the declared spectral region. The database may decide whether this radio is the only radio that can operate in the spectral region or it may allow other devices to share the spectral region. In some embodiments of the invention the declaration may contain a request for sole access to the spectral region that may or may not be granted sole access to the spectral region.

Within other embodiments of the invention the data may relate to a plurality of time periods and for each time period of the plurality of time periods a geolocations of a plurality of gcolocations. Accordingly, the spectrum availability provided by database for the radio's intended operation may be parsed by the database such that the spectrum availability is a series of spectrum availabilities, one for each time period and geolocation of the plurality of time periods. Alternatively, the spectrum availability may be one spectrum availability wherein the spectrum slices (ranges) within the spectrum availability are available for all time periods and their associated geolocations within the plurality of time periods. Alternatively, the radio may parse the series of spectrum availabilities to identify a spectral range supporting all time periods and their associated geolocations within the plurality of time periods or a minimum number of spectral ranges to support all time periods and their associated geolocations within the plurality of time periods minimizing reconfiguration of the radio.

Flow 1100 presents a flow wherein a periodic polling of the Network Database 1190 is performed. However, within other embodiments of the invention Flow 1100 may be executed once so that the radio operates within the declared spectrum until powered down, aperiodically or upon establishment of one or more trigger conditions being met. Aperiodic reconfiguration may be triggered upon detection of one or more events rather than trigger conditions being met. For example, a number of electronic devices associated with the radio (e.g., the radio is associated with an electronic device forming part of a base station) exceeds a predetermined fraction of the radio's capacity, drops below another predetermined fraction of the radio's capacity, a number of associated devices exceed a further predetermined fraction of the radio's capacity etc.

With respect to one or more trigger conditions these may, for example, be based upon monitoring of the spectral environment and/or performance of one or more wireless links between the radio and one or more other wireless devices, which may be other base stations, electronic devices etc. Spectral monitoring may for example determine that another transmitter is active within the declared spectrum even if it does not currently overlap with the operating frequency or frequencies of the radio. In contrast, performance monitoring may determine the presence of one or more of an interfering transmitter, a reduction in link signal-to-noise ratio (SNR), an increased bit error rate (BER), a decreased received power, etc.

Within process Flow 1100 a periodic polling of the Network Database 1190 is described as being performed to periodically obtain spectrum availability. However, within other embodiments of the invention the wireless device may perform a process itself of spectrum sensing to determine what spectrum can be transmitted upon. Within these embodiments of the invention the wireless device performs a spectral scan to measure and/or characterise the wireless environment to determine what spectrum is currently being transmitted upon.

Accordingly, spectral slices with wireless signals below a prescribed signal level for that spectral slice are then deemed available to the wireless device. The wireless device may then operate with or without communicating the selected spectrum slice to the database. However, where the wireless device wishes to declare a block of wireless spectrum larger than it actually transmits upon at any instant then this should be communicated to the database such that it is within the spectrum blocks declared that are communicated to subsequent wireless devices that then determine which channel (or spectrum slice) to operate upon based upon spectrum sensing within the free blocks.

Within embodiments of the invention the spectrum sensing may be based upon noise measurements made by the wireless device itself. Within other embodiments of the invention the spectrum sensing may be based upon channel measurements made by the wireless device itself which define characteristics of a signal within the slice in addition to its power level.

Within other embodiments of the invention the wireless device may perform a multi-step spectrum sensing process wherein in a first step the wireless device identifies free spectral slices through measurements, e.g. noise. Then in a second step the wireless device establishes one or more wireless links to one or more other wireless devices the wireless device seeks to communicate with, e.g., a BTS. Based upon assessment of the channel link quality (either unidirectionally or bidirectionally) of channels within the identified free spectral slices a channel selection or range selection (covering multiple channels) is established by the wireless device. This may be followed by updating the database as to the spectrum range the wireless device seeks to declare.

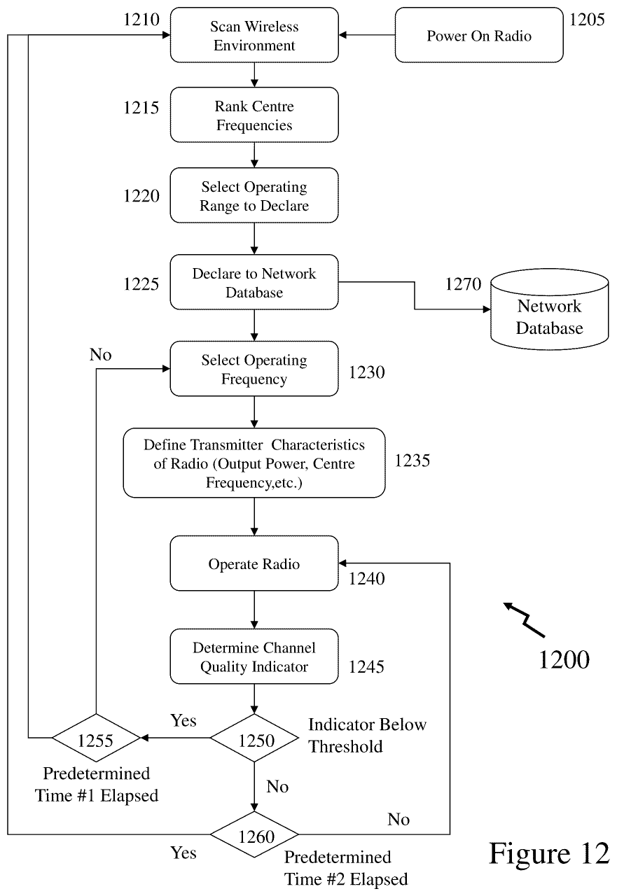

Now referring to FIG. 12 there is depicted a process Flow 1200 for configuring a wireless transmitter forming part of a wireless transceiver according to an embodiment of the invention. As depicted Flow 1200 comprises first to twelfth steps 1205 to 1260. The Flow 1200 accesses and pushes data to a Network Database 1270. These steps comprising:
First step 1205 wherein the wireless transceiver (radio) of the electronic device is powered on wherein the process proceeds to second step 1210.
Second step 1210 wherein the radio scans the wireless environment, for example, by scanning its receiver across the spectrum or via a separate spectrum analyser module forming part of the electronic device with the radio wherein the process proceeds to third step 1215.
Third step 1215 where the radio ranks potential centre frequencies of operation from the scan of the wireless environment before the process proceeds to fourth step 1220.
Fourth step 1220 wherein the radio selects an operating range to declare based upon the ranked potential centre frequencies established in third step 1215.
Fifth step 1225 wherein the radio transmits the selected operating range it is declaring to the Network Database 1270 wherein the process proceeds to sixth step 1230.
Sixth step 1230 wherein the radio selects an operating frequency within the selected operating range to operate upon before proceeding to seventh step 1235.
Seventh step 1235 wherein the radio defines the transmitter characteristics to be employed whilst transmitting within the identified largest spectral region, where these characteristics may include, but not be limited to, output power and centre frequency, wherein the process proceeds to eighth step 1240.
Eighth step 1240 wherein the electronic device operates the radio according to the characteristics established in seventh step 1235 wherein the process proceeds to eighth step 1245.
Ninth step 1245 wherein the radio determines a channel quality indicator which may, for example, be based upon a single link indicator of the channel or based a figure of merit established in dependence upon two or more link indicators of the channel.
Tenth step 1250 wherein the radio (or electronic device) determines whether the channel quality indicator has dropped below a threshold wherein upon a positive determination Flow 1200 proceeds to eleventh step 1255 otherwise it proceeds to twelfth step 1260.
Eleventh step 1255 wherein the radio (or electronic device) determines whether a predetermined period of time (Time #1) has elapsed, e.g. 24 hours, wherein upon a negative determination Flow 1200 loops back to sixth step 1230 to select another operating frequency otherwise it loops back to second step 1210.
Twelfth step 1260 wherein the radio (or electronic device) determines whether another predetermined period of time (Time #2) has elapsed, e.g. 24 hours, wherein upon a negative determination Flow 1200 loops back to eighth step 1240 to continue operating upon the previously selected operating frequency otherwise it loops back to second step 1210.

Flow 1200 presents a flow wherein network spectral characterisation, which may be established at the electronic device and/or upon characterisation of one or more uplinks and/or downlinks to the radio (wireless device such as PED, FED, or wearable device) is performed prior to determining the spectral operating range for the radio which is then transmitted to the Network Database 1270. Flow 1220 provides for selection of the operating range based upon either a predetermined period of time elapsing or upon a condition associated with a link dropping below a threshold condition. However, it would be evident that Flow 1220 may reset to the initial spectral scanning based upon establishment of one or more trigger conditions being met. For example, a number of electronic devices associated with the radio (e.g. the radio is associated with an electronic device forming part of a base station) exceeds a predetermined fraction of the radio's capacity, drops below another predetermined fraction of the radio's capacity, a number of associated devices exceed a further predetermined fraction of the radio's capacity etc.

Alternatively, eleventh step 1255 may be omitted and a determination that the channel quality indicator has dropped below a threshold in tenth step 1250 upon the positive determination loops Flow 1200 back to second step 1210.

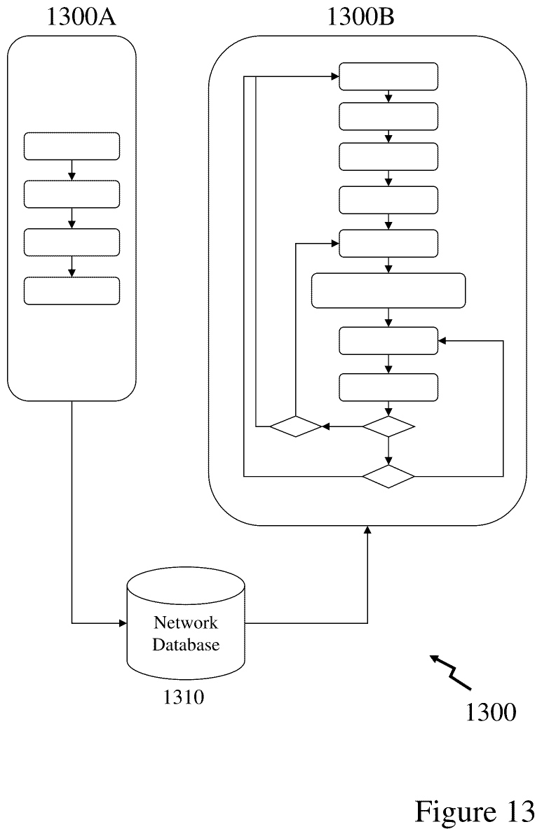

However, it would be evident to one of skill in the art that other process flows may be employed such as, for example, a hybrid mode between Flows 1100 and 1200 as depicted in FIG. 13 with Flow 1300. Within Flow 1300 the process comprises a first Flow 1300A and second Flow 1300B which cach act in combination with a Network Database 1310. Within first Flow 1300A a radio polls the Network Database 1310 such as described in second to fourth steps 1120 to 1150 of Flow 1100 in FIG. 11 to obtain free spectral region data from the Network Database 1310 and selecting the largest free spectral range. However, before updating the Network Database 1310 the radio proceeds to second Flow 1300B wherein it performs a scan of the selected largest free spectral range and then updates the Network Database 1310. The second Flow 1300B for example being similar to second to twelfth steps 1210 to 1260 in Flow 1200 in FIG. 12.

Within the process Flows 1200 to 1300 in FIGS. 12 to 13 periodic connectivity to the database and establishment of spectrum regions available to the radio is not described. However, it is in process Flow 1100 in FIG. 11. However, any process flow according to embodiments of the invention may support periodic “polling” of the database in order to comply with regulatory requirements as mandated by one or more of the frequency range of operation of the radio, the intended geolocation(s) of operation of the radio, time of operation of the radio, and an intended maximum output power of the radio for example.

For example, radios associated with fixed locations or so-called “Mode II” personal/portable devices (except for narrowband devices) which can employs its own geo-location capability, may be required under regulatory requirements, once powered on, to access a database (e.g., a white space database) at least once every predetermined time period (e.g., 60 minutes) to verify that the operating channel(s) and associated maximum power levels the radio has declared continue to be available at its location. Accordingly, a radio may adjust its channel usage in accordance with the most recent channel availability schedule information provided by the database for another predetermined time period (e.g. a two-hour period) beginning at the time of the radio last accessed the database for a list of available channels.

The regulatory requirements may further establish what the radio shall do if it fails to successfully contact the database, e.g. it may continue to operate until no longer than 120 minutes after the last successful contact, shutdown immediately, etc., until it reestablishes contact with the space database and re-verifies its list of available channels and associated maximum power levels

Within the following example, the scenario presented relates to the deployment of a transmitter for a rural network within white space, e.g. television white space (TVWS). Hence, for example, the polling of the Network Database for the Willowdale TiR Tower returns the results given in second Image 1000B in FIG. 10 wherein it is evident that there is a contiguous block from 470 MHz to 602 MHz free with a maximum Equivalent, Isotropically Radiated Power (EIRP) of +42 dBm within a 6 MHz band. Accordingly, the radio selects a block of available spectrum, for example 7 channels (42 MHz) within this free region, and the radio notifies the network database that it is seven channels, i.e. the network database is updated to reflect that the Willowdale TiR Tower is using all 42 MHz.

It would be evident that the radio occupied bandwidth must meet the regulatory limits and hence it will sit inside this block of 7 channels. However, which centre frequency will the radio actually use? If we consider UHF radios then current devices employ a 6 MHz raster and adhere to a channel plan, e.g. a digital television broadcast channel plan. However, if consider the case where an LTE radio is spectrum sensing then a frame can be used to sense the RF environment, although other RF spectrum sensing techniques may be used, with a raster much finer than 6 MHz, for example 250 kHz. Moreover, it would be evident that other radios may employ other even finer raster spacings, e.g. 100 kHz for example. It should be noted that an LTE radio, for example, may occupy bandwidths with nominal 5 MHz, 10 MHz, 15 MHz or 20 MHz settings although 5G occupied bandwidths may go higher. For example, a nominal 20 MHz bandwidth has an operating bandwidth (OBW) of approximately 18.2 MHz.

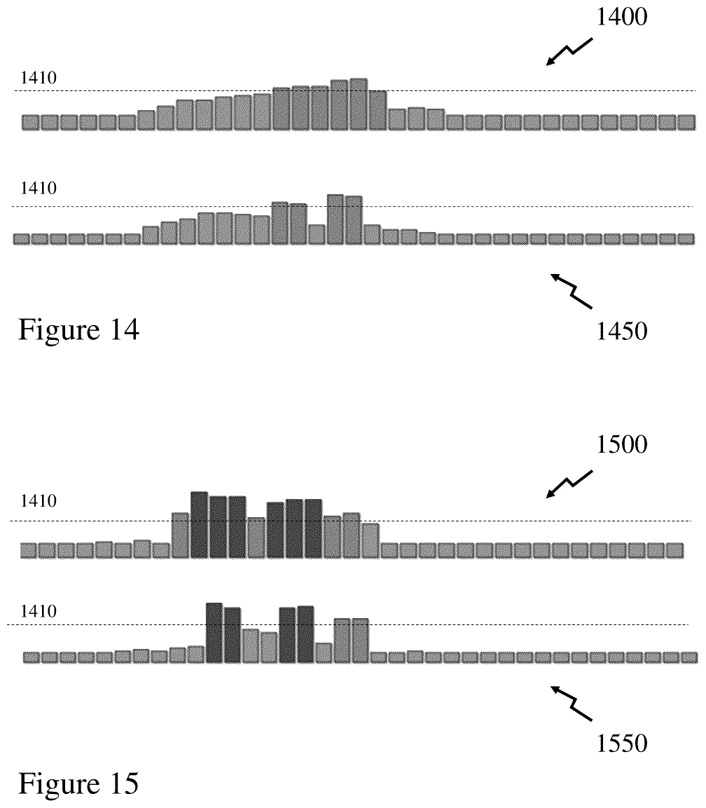

Accordingly, the radio can scan, for example at a raster finer than 6 MHz as described below and depicted in respect of FIGS. 14 and 15, and provide a ranking, e.g. automatically although other processes such as manual, AI based or ML based for example, centre frequencies from best-to-worst, for example, for its occupied bandwidth. This ranking may be based upon a figure-of-merit, for example, based upon one or more parameters of the spectral environment discretely or in combination with link measurements at these centre frequencies.

This spectral scanning permits avoidance of any interfering transmitters that are observed within the whole 7 channel block coming from sources such as, for example, a 5^{th} harmonic signal from a high power (e.g., >100 kW output power) FM transmitters which are for example −60 dBm/100 kHz. If, in contrast, a 6 MHz raster was used for the scanning it would be hard to avoid such interference peaks within the occupied bandwidth, a finer raster allows sitting between such interfering transmitters allowing deployments in areas not previously practical. A single harmonic peak of −60 dBm/100 kHz within an occupied bandwidth of a receiver of a radio can destroy the receiver's sensitivity and thereby throughput.

However, in order to meet regulatory requirements the radio must report to the database that it is using the whole of the 7 channel spectrum since the radio can change frequency, for example automatically as described above in although other processes such as manual, AI based or ML based for example may be employed within the defined spectrum block, e.g., the spectrum block as defined by a network database discretely, as described for example by Flow 1100 in FIG. 11, by the radio, as described for example by Flow 1200 in FIG. 12, or by a hybrid process based upon the network database and radio acting in concert. The radio may look for/change centre frequency if one or more channel quality indicators fall below a certain prescribed value. A boundary condition in each embodiment is that the occupied bandwidth of the radio remains within channels (frequency range) allocated or established by the database. Additionally, other boundary conditions such as those defined by regulatory requirements should also be complied with, where applicable. For example, in a TVWS application in North America regulatory requirements would require that the radio does not exceed concurrent conducted PSD limits of 12.6 dBm/100 kHz and 30 dBm/6 MHz and that the ACLR, in the United States (known as Adjacent Channel Power Leakage, ACPL, in Canada) meets the regulatory requirements. Examples of such ACLR limits as defined by Table 12 below for example.

Whilst the preceding description relates to the configuration/reconfiguration of a wireless device the following description relates to a software based solution for configuring a wireless radio to maximise the output power whilst complying with regulatory requirements such as Adjacent Channel Leakage Ratio (ACLR) and Power Spectral Density (PSD) either during compliance testing or during regular operation. For example the software algorithm may be implemented within a television white space (TVWS) radio that selects radio frequency channels for operation from a list of available channels provided by a TV band database, i.e. the database discussed above comprises a TV bands employed in the region of the wireless device installation and/or operation. Alternatively, the database may be a TVWS database, also referred to as a (TV) geolocation database, which controls TV spectrum utilization by unlicensed white spaces devices within a determined geographical arca.

The exemplary processes described above allow the inventor to have established a process to be employed by a radio allowing the output power to be increased relative to prior art radios whilst maintaining regulatory compliance against the ACLR requirements set by the Federal Communications Commission (FCC) in the United States and Innovation, Science and Economic Development Canada (ISED) in Canada. Accordingly, the inventor's innovative process provides a path to operating TVWS radio at 1 W per 6 MHz conducted power, i.e. 12.8 dBm/100 kHz, thereby supporting TVWS deployments in rural areas with increased range and/or throughput with improved SNR, or in some instances even viable. Typically prior art commercially certified radios are limited to 5-6 dBm/100 kHz. Accordingly, the innovative process offers a potential benefit of several dBm/100 kHz output power increase and thereby range and/or ability to accommodate environmental factors in rural deployments.

Within the following analysis it is assumed that the radio is an LTE radio, that the radio supports one or more of 10 MHz, 15 MHz and 20 MHz modulation, the links implemented are frequency-division duplexing (FDD) or time-division duplexing (TDD), and that the radio's centre frequency can be set with a raster of 1 MHz or lower.

FDD in combination with the approaches according to embodiments of the invention offer a significant advantage over TDD. This arises, as the RF environment at the BTS and the CPE, especially at UHF TVWS frequencies, can exhibit massively different noise and interference. In LTE FDD the uplink and downlink bandwidths can be different, e.g., the downlink is 20 MHz and the upload is 10 MHz. This allows for the radio to fine tune to clean blocks of spectrum independently at the BTS and the CPE thereby improving performance.

Considering FCC and ISED regulatory requirements for TVWS deployments then the following boundary conditions are applicable:
The conducted power per 6 MHz channel cannot exceed 30 dBm (average per 6 MHz in the case of contiguous channel bonding) or 27 dBm per spatial stream in the case of 2×2 MIMO.
The ACLR absolute value at N+/−1 of the available channels defined, by the network database for example, cannot exceed −42.8 dBm/100 kHz or −45.8 dBm/100 kHz if conducted per spatial stream in the case of 2×2 MIMO. The inventor notes that there are other N+/−2, out-of-band and in-band limits but that ACLR is the primary challenge.
The PSD of the conducted power of the modulation cannot exceed 12.6 dBm per 100 kHz or 9.6 dBm/100 kHz per spatial stream in the case of 2×2 MIMO.

Accordingly, if we assume 20 MHz modulation and 9.6 dBm/100 kHz then the radio requires 9.6+23 dBm/20 MHz=32.6 dBm output per 20 MHz per spatial stream, i.e. just under 2 W per spatial stream. The figures referenced above are correct if the EIRP limit from the database to the radio is specified as +42 dBm per 6 MHz. It would be evident that the ACLR limit would vary with the allowed EIRP per channel provided from the database and the gain of the antennas of the radio.

Now consider that we are seeking to operate with the Willowdale TiR Tower then the database will return information such as presented in FIG. 10. Considering the contiguous block from 470 MHz−602 MHz at 42 Bm/6 MHz channel then this is met with a +30 dBm conducted output power from the radio in combination with a +12 dBi antenna. It should be noted that the TV broadcast band is 470 MHz−790 MHz (see ETSI EN 301 598 for the harmonized European standard for white space devices in TV broadcast band).

Now, let us assume that the radio declares to the network database that it will have a bandwidth of operation to be 30 MHz or 5 contiguous channels. This allows for a modulation that 29.5 MHz or less as there is a requirement to not modulate the 250 kHz either side of the band on the used channels. Now, consider that we employ 20 MHz modulation and so the 99% occupied bandwidth is nominally 19 MHz, as defined by Section 6.7 in Canadian Radio Standards Specification RSS-222 Issue 3 “White Space Devices (WSDs).”

With 20 MHz modulation centered in the 30 MHz declared band, the radio operates with 5 MHz of guard band either side of the occupied bandwidth. The spectrum availability from the database determines where, according to the standards, the ACLR and other measurements are taken. As the radio in this example has declared itself to be operating in the 5 channel mode then the ACLR is measured at 15 MHz from the centre of the occupied bandwidth. More generally, we obtain the ACLR measurement points as outlined in Table 12 below for a radio that declares itself to be operating in 4, 5 or 6 channel modes.

TABLE 12
ACLR Measurement Frequency Offset versus Channel
Mode Declared for 20 MHz Modulation

| | Occupied | | Centre of occupied |
|---|---|---|---|
| Channel | Bandwidth | Guard band | bandwidth to ACLR |
| Mode | (99%) | either side | N + 1 measurement |
| 4 | 19 MHz | 2 MHz | 12 MHz |
| 5 | 19 MHz | 5 MHz | 15 MHz |
| 6 | 19 MHz | 8 MHz | 18 MHz |

From a practical perspective this means giving up a block of spectrum either side of the contiguous spectrum made available from the database. This also determines a minimum and maximum centre frequency for the contiguous block. However, the eased ACLR compliance with increased output power allows the radio to operate in rural environments within TVWS which are currently inaccessible to commercial deployments or have limited commercial deployments due to the achievable performance.

Consider, for example, that a block of 8 contiguous channels is accessible from the network database, e.g. 470 MHz−518 MHz. The radio declare itself as a 6-channel radio. Then the minimum centre frequency the radio can operate at is 488 MHz (470 MHz+18 MHz) and the maximum is 500 MHz (518 MHz−18 MHz). The radio can then operate at any centre frequency from 488 MHz to 500 MHz with an LTE raster of 100 kHz, creating 120 separate channel options.

The processes and configuration of the radio according to embodiments of the invention can be implemented within software, e.g., base station software, as the CPE will scan and connect to an available base station.

It would be evident that the process(es) according to embodiments of the invention may further include a sub-process wherein the radio by changing its declared bandwidth to generate different channel offsets can ensure broadcast regulatory requirements are met at its installed location.

It would be further evident that whilst the above descriptions have been outlined with respect to LTE radios that 5G radios, where higher occupied bandwidths are available, can be configured using the same processes.

At present, commercial radio manufacturers declare an occupied bandwidth slightly larger, e.g., 12 MHz, than the modulation rate, e.g., 10 MHz in this instance. Accordingly, the offset between the occupied bandwidth and the frequencies at which the ACLR is measured are small and as such, because of the strict spectral mask limits, certification of TVWS radios is extremely difficult and even more so where these are frequency agile at power levels close to the regulatory limits. Whilst certification at higher conducted powers close to the regulatory limits could be achieved with prior art radios this requires very high rejection filters, e.g. 9 or more clement Chebyshev filters, which are both expensive and would prevent frequency agility.

Within embodiments of the invention described above a wireless device may perform a scan to determine a channel within a reserved frequency block upon which to operate. However, where the wireless device supports multiple sectors, e.g. the wireless device has multiple antennae supporting different spatial orientations, e.g. the wireless device is a BTS, then the determination may be different for specific sectors of coverage of the wireless device. As outlined previously in rural environments multiple factors can influence the wireless environment including, for example, weather, time of year, etc. Accordingly, a sector with substantial clear terrain may be different in terms of channel performance on specific channels to another sector with substantial coverage of woodland, forest etc. and the difference between these sectors may vary seasonally. Alternatively, one sector may be prone to fog in contrast to another.

Accordingly, the determination of a channel may be different per sector or may be an aggregated selection based upon the multiple sectors. In other embodiments of the invention a determination may also be made of a modulation format for wireless links within a sector, e.g. whether to employ Frequency Division Duplexing (FDD) or Time Division Duplexing (TDD) for example where the wireless devices can support both.

FIGS. 14 and 15 depict exemplary results for a wireless cell tower where results are presented for antenna azimuths of 148° and 334°, i.e. for different directions relative to the cell tower's zenith. Further, as evident from FIGS. 14 and 15 the assessment of channel performance and/or determination of a channel is also influenced by the raster employed for the channel scan. In essence, wireless devices such as BTS and CPE can have widely different RF environments in different directions and a raster at a high frequency, e.g. 6 MHz, can yield data making the determination difficult and identifying channels to operate upon that provide good performance difficult.

Referring to first Plot 1400 in FIG. 14 and first Plot 1500 in FIG. 15 channel noise measurements for a BTS with a channelization filter of approximately 30 MHz bandwidth are presented for a first sector (azimuth)148° and a second sector (azimuth 334°) with a 4 channel noise scan as would be employed in a 20 MHz TDD link (e.g. uplink). In each of the first Plot 1400 in FIG. 14 and first Plot 1500 in FIG. 15 the measured noise is plotted through the raster scan with a threshold 1410 depicted representing a pass/fail condition for the set of channels scanned. Accordingly, from these measurements selection of a good channel option is difficult.

However, if the bandwidth is reduced to a 2 channel noise scan, as would be used in a 10 MHz FDD link (e.g. uplink), then the results depicted in second Plot 1450 and second Plot 1550 are obtained. From these measurements a useable channel is easier to identify. Accordingly, transitioning from a 20 MHz TDD uplink to a 10 MHz FDD uplink in this example makes the network viable even in noisy environments at the wireless device (e.g. a BTS) or where spectrum availability (as established through data retrieved from a database) is limited.

Accordingly, a wireless device may employ TDD and/or FDD in combination with a spectrum mapping retrieved from a database to spectrally “mine” for optimum spectral blocks and modulation format(s) for the uplink(s) and downlink(s) from and to the wireless device.

Accordingly, the transmit and receive environments may be different. With TDD there is a comprise on the channel quality indicator (CQI) options for uplink and downlink where minimum thresholds are met for a specific centre frequency. However, for FDD these are optimised independently.

Within this specification the radio declares to a database what spectral region or spectral regions it intends to operate upon. Within the specific scenario of TWVS this band is unlicensed wherein the database provides the radio with spectral regions that are legal for the radio to use on a no-interference, no-protection basis. The database can also advise the radio what other users there are in the area within embodiments of the invention. However, within the TVWS scenario the database cannot impart a restriction on making spectrum available (or not) to a specific radio. However, within other scenarios such as a separate internal, or cloud based, radio management system the database could impart such a restriction.

In most cases the radio “reports” to the database frequently what channel it is using in case there is a change in spectrum availability on a time period (commonly referred to as T_{UPDATE}), e.g. hourly, every 10 minutes, etc., which is shorter than an availability period of the system, e.g. 1 hour, 12 hours, 24 hours, etc. (commonly referred to as T_{AVAILABIIITY}). However, within other embodiments of the invention such as a separate internal, or cloud based, radio management, for example, the radio once it has declared a spectral region may be provided with a period of time that the radio can operate upon this spectral region by the database. Optionally, in such scenarios the radio may include within its declaration a period of time that it wishes to declare use of the spectral region which is acknowledged and/or validated by the database.

Optionally, a spectrum database may operate in two or more approaches according to the spectral regions it covers and/or the geographical area it relates to. For example, the database may operate upon a “permission” basis wherein radios are operating within a no protection/no interference environment and/or a “time dependent license” basis. In some embodiments of the invention one geographic region covered by the database may be on one basis whilst another geographic region also covered by the database may be on another basis.

Within the embodiments of the invention the “best” spectrum for a radio to operate upon may not be within the largest spectral block available as defined in the data from the database. For example, there may be a spectral region of 6 blocks available which is separated from another spectral region of 4 blocks by an occupied region. The larger spectral region, 6 blocks, may not have the “best” link performance. Accordingly, the radio may select the spectral region of 4 blocks as being the one the radio elects to the database. Accordingly, the radio may receive the free spectral regions from the database, perform an analysis of the free spectral regions (e.g., by establishing wireless links within the free spectral regions, spectral scanning, etc.).

Optionally, within an embodiment of the invention the radio may declare a non-contiguous block to the database. For example, a radio seeking to declare a 20 MHz spectral region may instead of declaring a single 20 MHz contiguous block declare a 10 MHz block within one spectral region and another 10 MHz block within another spectral region. Accordingly, rather than the radio identifying a free spectral region of a number of available spectral regions for the location that the radio wishes to declare operation upon the radio may identify a predetermined portion of the free spectral region of a number of available spectral regions for the location that the radio wishes to declare operation upon.

It would be evident to one of skill in the art that the methods and processes outlined below with respect to embodiments of the invention may be applied to different wireless systems, regions of the wireless spectrum etc. without departing from the scope of the invention. For example, systems designed to operate within a white space environment, for example what is known as television (TV) white space (TVWS) between about 50 MHz and 700 MHz, suffer similar issues in respect of identifying clean spectrum blocks as systems operating within the unlicensed 5 GHz spectrum for example and therefore can exploit processes as described albeit within different frequency ranges and applications to adjust scanning/channel selection/modulation format.

Similarly, wireless devices seeking to operate within an environment with geographic/temporal regulated spectrum obtaining spectral data from a database may exploit similar processes according to embodiments of the invention to establish declaration of a spectral block and operation within the resulting network at increased power, for example, whilst complying with regulatory requirements. Accordingly, a wireless device seeking to operate within the TVWS accessing a database (a (TV) geolocation database) may exploit processes that are also executed within another wireless device which is operating within the 6 GHz region with spectral data established from an Automated Frequency Coordination (AFC) database, e.g., for wireless devices supporting what is known as Wi-Fi 6E.

Within the embodiments of the invention described and depicted above examples of the database have been presented with respect to a white space database, e.g. a TV white space database. However, within embodiments of the invention the radio transmits to the network database data identifying that the wireless device intends to operate within a free spectral region of a number of available spectral regions identified in data provided by the network database for operating location of the radio having the largest range. Accordingly, within other embodiments of the invention a database providing spectrum availability to radios may limit access to the database to a defined group of radios. Alternatively the database may parse the database information such that only a subset of the database information is provided to radios within a first defined group whilst providing all of the database information or another subset of the database information to radios within a second defined group.

Accordingly, the database within embodiments of the invention can arbitrate between radios or sets of radios as to which portions of the spectrum they can access. Within another embodiment of the invention the database may parse the database information to provide a radio based upon information acquired by the database from radios relating to quality of service, link performance, etc. such that the database may, for example, provide one subset of the database information to a radio at a geographic location at one time versus another subset of the database information to the radio at the geographic location at another time, e.g. to account for seasonal variations of the environment impacting wireless links for example. Alternatively, the different information may account for the geolocation of one device being in a valley versus another being on a hill. Alternatively, the current weather is rain or snow such that one set of channels have historically better performance to that geolocation versus when it is dry and clear. Accordingly, the database may be linked to one or more other databases such as providing weather data, news, etc. or other sources of information such as weather radar, emergency service posts etc. such that the spectrum ranges provided to radios may factor in such additional sources of information.

For example, an emergency services or military message, for example, relating to a geolocation may result in the database blocking additional radios or may limit access to certain portions of the spectrum to radios associated with the emergency services, military, etc. Optionally, a geofence may be established relating to an incident that impacts only spectrum options provided to radios within the geofence. Alternatively, the weather information may be that projected for a term of authorisation for the radio to transmit or the period until the radio should re-poll the database.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
establishing a location of a wireless device;
polling a network database to establish data relating to a number of available spectral regions for the location;
identifying a largest continuous range within the number of available spectral regions for the location as a range the wireless device wishes to declare operation upon;
transmitting to the network database data identifying that the wireless device intends to operate upon the identified largest continuous range within the number of available spectral regions at the location;
updating the network database such that the identified largest continuous range within the number of available spectral regions is reserved for that location; and
defining in dependence upon the largest continuous range within the number of available spectral regions one or more transmitter characteristics with which to operate a transmitter forming part of the wireless device at the location.

2. The method according to claim 1, wherein the largest continuous range comprises two or more spectral regions of the number of available spectral regions for that location.

3. The method according to claim 1, wherein defining the one or more transmitter characteristics comprises:
defining a modulation bandwidth;
establishing an adjacent channel leakage ratio (ACLR) requirement for the radio as defined by a regulatory requirement associated with the location and the reserved free spectral region of the number of available spectral regions for the location; and
establishing an output power for the transmitter to comply with the ACLR requirement.

4. The method according to claim 1, wherein
the data relating to the number of available spectral regions for the location is established by the database from a larger set of available spectral regions;
the data relating to the number of available spectral regions for the location is established in dependence upon at least one of:
the location;
a time associated with the polling;
data relating to an ambient environment at the location for a predetermined period of time after the polling request being made;
a geofence relating to an incident at another location; and
historical data relating to link performance for the location stored within at least one of the database and another database.

5. A device comprising:
a wireless transmitter;
a processor; and
a memory storing computer executable instructions which when executed by the processor configure the device to:
establish a location of the device;
poll a network database to establish data relating to a number of available spectral regions for the location;
identify a largest continuous range within the number of available spectral regions for the location as a range the device wishes to declare operation upon;
transmit to the network database data identifying that the device intends to operate upon the identified largest continuous range within the number of available spectral regions at the location; and
define in dependence upon the largest continuous range within the number of available spectral regions one or more transmitter characteristics with which to operate a transmitter forming part of the device at the location.

6. The device according to claim 5, wherein the data transmitted from the wireless transmitter to the network database is employed to update the network database such that the identified largest continuous range within the number of available spectral regions is reserved for that location.

7. The device according to claim 5, wherein defining the one or more transmitter characteristics comprises:
defining a modulation bandwidth;
establishing an adjacent channel leakage ratio (ACLR) requirement for the radio as defined by a regulatory requirement associated with the location and the reserved free spectral region of the number of available spectral regions for the location; and
establishing an output power for the transmitter to comply with the ACLR requirement.

8. The method according to claim 5, wherein the data relating to the number of available spectral regions for the location is established by the database from a larger set of available spectral regions;
the data relating to the number of available spectral regions for the location is established in dependence upon at least one of:
the location;
a time associated with the polling;
data relating to an ambient environment at the location for a predetermined period of time after the polling request being made;
a geofence relating to an incident at another location; and
historical data relating to link performance for the location stored within at least one of the database and another database.

9. A method comprising:
powering on a wireless transceiver (radio) of an electronic device;
scanning with the radio a region of a wireless environment at a location of the electronic device;
ranking potential centre frequencies of operation identified by a microprocessor associated with the radio from the scan of the region of the wireless environment;
selecting with the microprocessor an operating range for the electronic device to declare based upon the ranked potential centre frequencies;
transmitting data relating to the selected operating range the electronic device is declaring to a network database;
selecting with the microprocessor an operating frequency within the selected operating range to operate upon;
defining with the microprocessor transmitter characteristics of a wireless transmitter forming part of the radio to be employed whilst transmitting upon the operating frequency; and
transmitting data from the electronic device with the radio.

10. The method according to claim 9, wherein the selected operating range is the largest spectral region within the scanned region which is free for the radio to transmit upon.

11. The method according to claim 9, wherein scanning with the radio the region of the wireless environment is performed by one of the radio scanning a receiver forming part of the radio across the region of the wireless environment or by a spectrum analyser module forming part of the electronic device.

12. The method according to claim 9, further comprising determining with the microprocessor a channel quality indicator of a channel of a link comprising the radio;
determining whether the channel quality indicator is below a threshold;
upon a positive determination that the channel quality indicator is below the threshold determining with the microprocessor whether a predetermined period of time has elapsed wherein;
upon a negative determination that the predetermined period of time has elapsed proceeding back to the step of selecting the operating frequency to select another operating frequency within the selected operating range; and
upon a positive determination that the predetermined period of time has elapsed proceeding back to the step of scanning with the radio the region of the wireless environment at the location of the electronic device; and
upon a negative determination that the channel quality indicator is below the threshold determining with the microprocessor whether another predetermined period of time has elapsed wherein;
upon a negative determination that the another predetermined period of time has elapsed proceeding to the step of transmitting data from the electronic device with the radio; and
upon a positive determination that the another predetermined period of time has elapsed proceeding back to the step of scanning with the radio the region of the wireless environment at the location of the electronic device.

13. The method according to claim 12, wherein the channel quality indicator is either a single link indicator of the channel of the link or a figure of merit established in dependence upon two or more link indicators of the channel of the link.

14. The method according to claim 9, further comprising determining whether a trigger condition has been met; and
upon determining that the trigger condition of one or more trigger conditions has been met proceeding back to the step of scanning with the radio the region of the wireless environment at the location of the electronic device; wherein
the trigger condition is selected from the group comprising:
that a number of devices associated with the radio exceeds a predetermined fraction of a capacity of the radio; and
that a number of devices associated with the radio is below another predetermined fraction of the capacity of the radio.
